(19) United States
(12) Patent Application Publication
(10) Pub. No.: US 2009/0161047 A1
(43) Pub. Date: Jun. 25, 2009

(54) COLOR FILTER SUBSTRATE FOR LIQUID CRYSTAL DISPLAY AND METHOD FOR MANUFACTURING THE SAME

(75) Inventors: Woo-Sik Cho, Seoul (KR); Ji-Young Jeong, Cheonan-si (KR); Ju-Hyeon Baek, Cheonan-si (KR); Chang-Soo Han, Seoul (KR); Eung-Gyu Lee, Cheonan-si (KR)

Correspondence Address: H.C. PARK & ASSOCIATES, PLC, 8500 LEESBURG PIKE, SUITE 7500, VIENNA, VA, 22182, US

(73) Assignee: SAMSUNG ELECTRONICS CO., LTD., Suwon-si (KR)

(21) Appl. No.: 12/261,607

(22) Filed: Oct. 30, 2008

(30) Foreign Application Priority Data
Dec. 20, 2007 (KR) 10-2007-0133990

(51) Int. Cl. G02F 1/1335; G09G 3/28

(52) U.S. Cl. 349/106; 345/64

(57) ABSTRACT

A color filter substrate for a liquid crystal display (LCD) includes a substrate having a non-pixel region and a pixel region, a black matrix and a light blocking color filter layered in the non-pixel region, and a color filter arranged in the pixel region. The light blocking color filter may be formed simultaneously with the color filter, and may include color filter material having light blocking properties at various wavelengths to supplement the light blocking properties of the black matrix. The light blocking color filter occupies a portion of the non-pixel region and has a thickness so that the black matrix in the non-pixel region may have a thickness that is less than a thickness of the color filter arranged in the pixel region.

### CROSS-REFERENCE TO RELATED APPLICATION

This application claims priority from and the benefit of Korean Patent Application No. 10-2007-0133990, filed on Dec. 20, 2007, which is hereby incorporated by reference for all purposes as if fully set forth herein.

### BACKGROUND OF THE INVENTION

1. Field of the Invention

The present invention relates to a liquid crystal display, and more particularly, to a color filter substrate for a liquid crystal display and a method for manufacturing the same.

2. Discussion of the Background

A liquid crystal display (LCD) displays an image by adjusting a light transmission amount through a liquid crystal by applying an electric field to the liquid crystal. For this, the LCD includes a liquid crystal panel in which liquid crystal cells are arranged in a matrix format and a drive circuit for driving the liquid crystal panel. In the liquid crystal panel, a common electrode and pixel electrodes apply an electric field to the liquid crystal cells.

The pixel electrodes are arranged on a lower substrate, and each pixel electrode may correspond to one liquid crystal cell, whereas the common electrode may correspond to all pixel electrodes. The common electrode may be arranged on the entire surface of an upper substrate. Each pixel electrode may be connected to a thin film transistor (TFT) used as a switching element. The pixel electrode drives the liquid crystal cell together with the common electrode in response to a data signal supplied through the TFT.

An LCD may also have a color filter including red (R), green (G), and blue (B) sub-pixels to emit red (R), green (G), and blue (B) light to realize a full-color display. The brightness of the light transmitted through the liquid crystal cell and then through the corresponding color filter of a sub-pixel is controlled to permit the LCD to realize the full-color display.

The LCD also has a black matrix for preventing light leakage between sub-pixels. This black matrix generally includes a metal film such as chromium (Cr) and an organic material of a carbon-based system, and has a sufficient thickness to prevent light leakage between the red (R), green (G), and blue (B) sub pixels.

There is a constant need for reducing the cost of manufacturing LCDs without a corresponding reduction in image quality.

### SUMMARY OF THE INVENTION

This invention provides a color filter substrate for an LCD that may have reduced costs to manufacture a black matrix.

This invention also provides a method for manufacturing a color filter substrate for an LCD that can reduce the cost of manufacturing a black matrix.

Additional features of the invention will be set forth in the description which follows, and in part will be apparent from the description, or may be learned by practice of the invention.

The present invention discloses a color filter substrate for an LCD including a substrate including a non-pixel region separating a first pixel region from a second pixel region, and a black matrix layered with a light blocking color filter in the non-pixel region. The light blocking color filter includes a first color filter overlapping with a second color filter. Further, the first color filter extends into the first pixel region and the second color filter extends into the second pixel region.

The present invention also discloses a method for manufacturing a color filter substrate, including forming a black matrix in a non-pixel region of a substrate. The black matrix separates a first pixel region from a second pixel region. The method also includes forming a first color filter in the first pixel region, forming a second color filter in the second pixel region, and forming a light blocking color filter in the non-pixel region. Further, the light blocking color filter includes the first color filter and the second color filter.

The present invention also discloses an LCD including a substrate including a first pixel region arranged between a first non-pixel region and a second non-pixel region, and a second pixel region arranged between the second non-pixel region and a third non-pixel region, a black matrix arranged in each of the first non-pixel region, the second non-pixel region, and the third non-pixel region, a first color filter arranged in the first pixel region, the first non-pixel region, and the second non-pixel region, and a second color filter arranged in the second pixel region, the second non-pixel region, and the third non-pixel region. Further, the first color filter overlaps with the second color filter in the second non-pixel region.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is an exploded perspective view showing an LCD panel including a color filter substrate according to an exemplary embodiment of the present invention.

FIG. 2A is a plan view showing a color filter substrate for an LCD according to an exemplary embodiment of the present invention.

FIG. 2B is a cross-sectional view of a section taken along line I-I′ shown in FIG. 2A.

FIG. 3 is a graph representing the spectra of red, green, and blue.

FIG. 4A, FIG. 4B, FIG. 4C, FIG. 4D, FIG. 4E, FIG. 4F, FIG. 4G, and FIG. 4H are cross-sectional views illustrating a method for manufacturing the color filter substrate for the LCD according to another exemplary embodiment of the present invention.

FIG. 5A, FIG. 5B, and FIG. 5C are cross-sectional views illustrating a method for manufacturing the color filter substrate for the LCD according to another exemplary embodiment of the present invention.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

It will be understood that when an element such as a layer, film, region or substrate is referred to as being “on” another element, it can be directly on the other element or intervening elements may also be present. In contrast, when an element is referred to as being “directly on” another element, there are no intervening elements present.

Hereinafter, exemplary embodiments of the present invention will be described in detail with reference to the drawings.

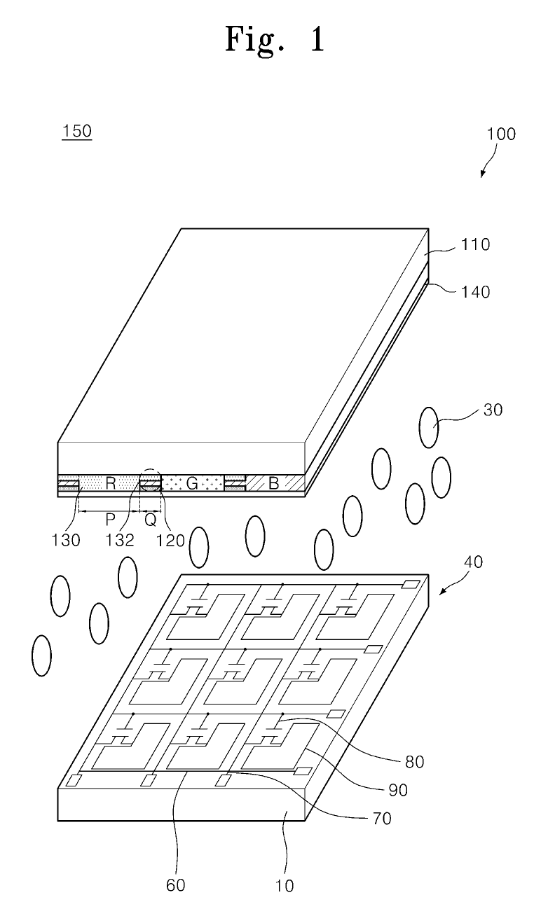

FIG. 1 is an exploded perspective view showing an LCD panel including a color filter substrate according to an exemplary embodiment of the present invention.

As shown in FIG. 1, an LCD panel 150 includes a TFT substrate 40, a color filter substrate 100, and liquid crystal 30 interposed between the TFT substrate 40 and the color filter substrate 100.

The liquid crystal 30 may be made of a material with an anisotropic dielectric constant and an anisotropic refractive index. The liquid crystal 30 may be rotated due to a potential difference between a pixel voltage of a pixel electrode 90 on the TFT substrate 40 and a common voltage of a common electrode 140 on the color filter substrate 100 to adjust a light transmission amount through the liquid crystal 30.

The TFT substrate 40 includes a gate line 60 and a data line 70 arranged to cross with each other on a lower substrate 10, a TFT 80 arranged where the gate line 60 and the data line 70 cross with each other, and the pixel electrode 90 arranged in a pixel region.

The TFT 80 supplies a data voltage from the data line 70 to the pixel electrode 90 in response to a scan signal supplied from the gate line 60. For this, the TFT 80 may include a gate electrode, a source electrode, a drain electrode, an activation layer insulated from the gate electrode, and an ohmic contact layer.

The pixel electrode 90 is charged with a pixel voltage according to a data voltage supplied from the TFT 80 and a potential difference is generated between the pixel electrode 90 and the common electrode 140. According to the potential difference, the liquid crystal 30 located between the TFT substrate 40 and the color filter substrate 100 is rotated due to the dielectric constant anisotropy and causes light from a backlight assembly to be transmitted toward the color filter substrate 100 by adjusting an amount of light incident via the pixel electrode 90.

The color filter substrate 100 includes a black matrix 120, a color filter 130, and the common electrode 140 arranged on an upper substrate 110.

The color filter substrate 100 is divided into a pixel region P and a non-pixel region Q.

The non-pixel region Q includes the black matrix 120 and a light blocking color filter 132 arranged on the black matrix 120. The light blocking color filter 132 may be a blue light blocking color filter formed with a blue color resist and stacked in a layer with a red light blocking color filter formed with a red color resist. However, the light blocking color filter 132 is not limited thereto, and can include at least one of light blocking color filters 132 of R, G, and B.

The pixel region P includes the color filter 130 for realizing the colors of R, G, and B in a sub-pixel. The color filter 130 for realizing the colors has separate R, G, and B regions that respectively transmit red, green, and blue light. The color filter 130 R, G, and B regions are divided by the black matrix 120 and the light blocking color filter 132.

The light blocking color filter 132 layered on the black matrix 120 can function as a black matrix. The black matrix 120 and the light blocking color filter 132 divide the upper substrate 110 into cell regions, and the color filter 130 is arranged in the pixel region P of the cell regions in the upper substrate 110. The black matrix 120 and the blocking color filter 132 prevent light interference and external light reflection between adjacent cell regions. For this, the black matrix 120 and the light blocking color filter 132 may be arranged on the upper substrate 110 to overlap with at least one of the data line 70, the gate line 60, and the TFT 80 arranged on the lower substrate 10.

The common electrode 140 supplies a common voltage serving as a reference voltage if the liquid crystal 30 operates as a transparent conductive layer.

In general, the LCD panel 150 expresses pixels through a polarizing process and may include polarizing plates on the outer surfaces of the TFT substrate 40 and the color filter substrate 100.

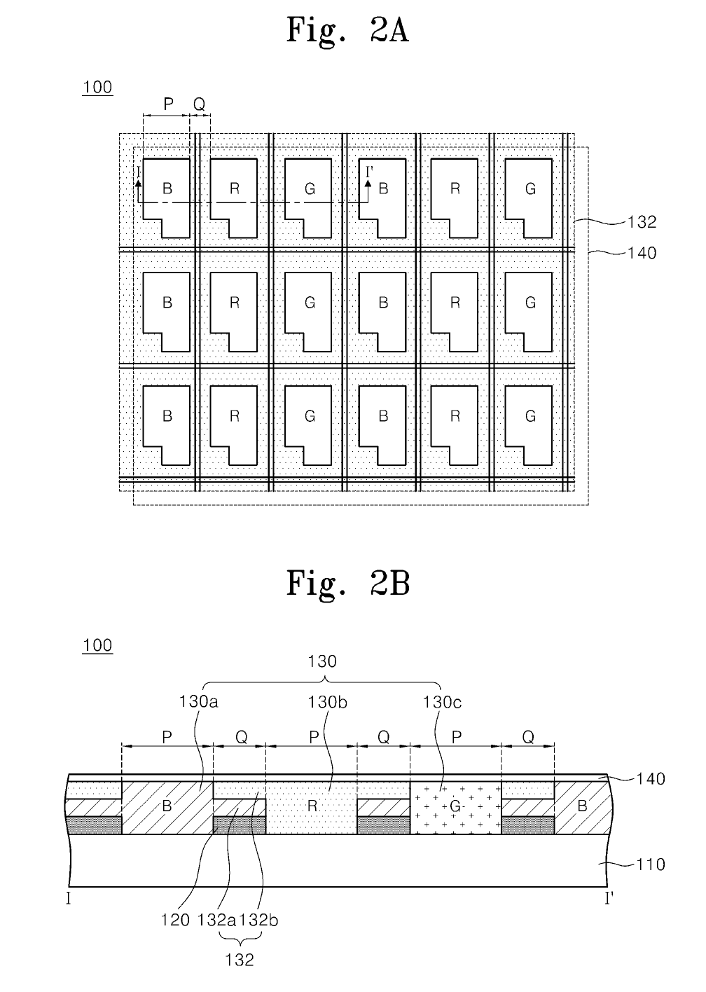

FIG. 2A is a plan view showing the color filter substrate for an LCD according to an exemplary embodiment of the present invention, and FIG. 2B is a cross-sectional view of a section taken along line I-I′ shown in FIG. 2A.

As shown in FIG. 2A and FIG. 2B, a color filter substrate 100 for the LCD according to an exemplary embodiment of the present invention includes an upper substrate 110, a black matrix 120, a color filter 130 for realizing colors, a light blocking color filter 132, and a common electrode 140. The color filter substrate 100 can be divided into pixel regions P and non-pixel regions Q. In the pixel region P, color filters 130a, 130b, and 130c for realizing the blue (B), red (R), and green (G) colors are arranged in B, R, and G sub-pixel units, respectively. The non-pixel region Q includes the black matrix 120 and the light blocking color filter 132 in which a blue light blocking color filter 132a and a red light blocking color filter 132b may be layered on the upper substrate 110.

The black matrix 120 can have a thickness of 0.5 μm to 1.0 μm. The light blocking characteristics of the black matrix 120 may be degraded if the black matrix 120 has a thickness less than 0.5 μm, and the material cost of the black matrix 120 may increase unnecessarily if the black matrix 120 has a thickness greater than 1.0 μm. Thus, the black matrix 120 having the above-mentioned thickness can effectively reduce the material cost, and the light blocking color filter 132 layered on the black matrix 120 can supplement the light blocking properties of the black matrix 120 to minimize image quality deterioration.

The light blocking color filter 132 layered on the black matrix 120 can have a thickness of 0.5 μm to 1.05 μm. If the light blocking color filter 132 has a thickness less than 0.5 μm, the light blocking characteristics of the light blocking color filter 132 may be degraded. If the light blocking color filter 132 has a thickness more than 1.05 μm, the thickness of the black matrix 120 may have to be reduced accordingly such that the light blocking characteristics of the black matrix 120 are reduced. The light blocking color filter 132 having the above-mentioned thickness can effectively perform a black matrix function without significant additional material cost.

In comparison with a conventional black matrix, an amount of resin used to manufacture the black matrix is reduced by 50% or more and the remaining region is replaced with a color resist normally used to manufacture only the color filter 130.

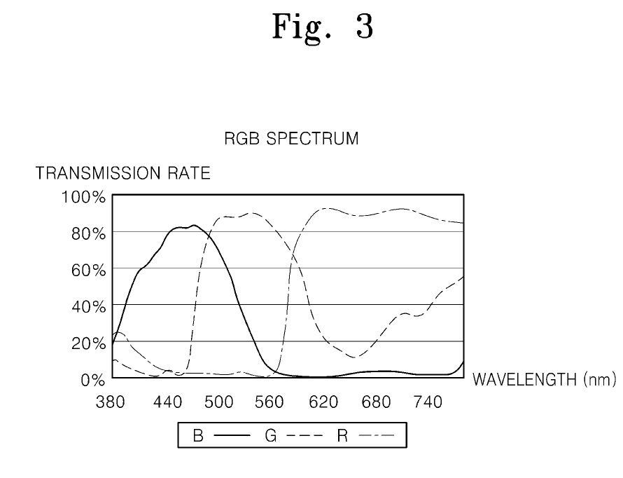

FIG. 3 is a graph representing the spectra of red, green, and blue.

As shown in FIG. 3, the spectrum of blue (B) among the spectra of red (R), green (G) and blue (B) exhibits a high transmission rate characteristic in a relatively short wavelength band of 400 nm to 500 nm, and the spectrum of red (R) exhibits a high transmission rate characteristic in a relatively long wavelength band of 600 nm to 700 nm or more.

Therefore, the exemplary embodiment of the present invention uses a blue (B) color resist having characteristics of transmitting only a short wavelength and absorbing others and a red (R) color resist having characteristic of transmitting only a long wavelength and absorbing others. Accordingly, in combination, the blue (B) color resist and the red (R) color resist can absorb lights of most wavelengths and the light shielding effect of the black matrix can be achieved.

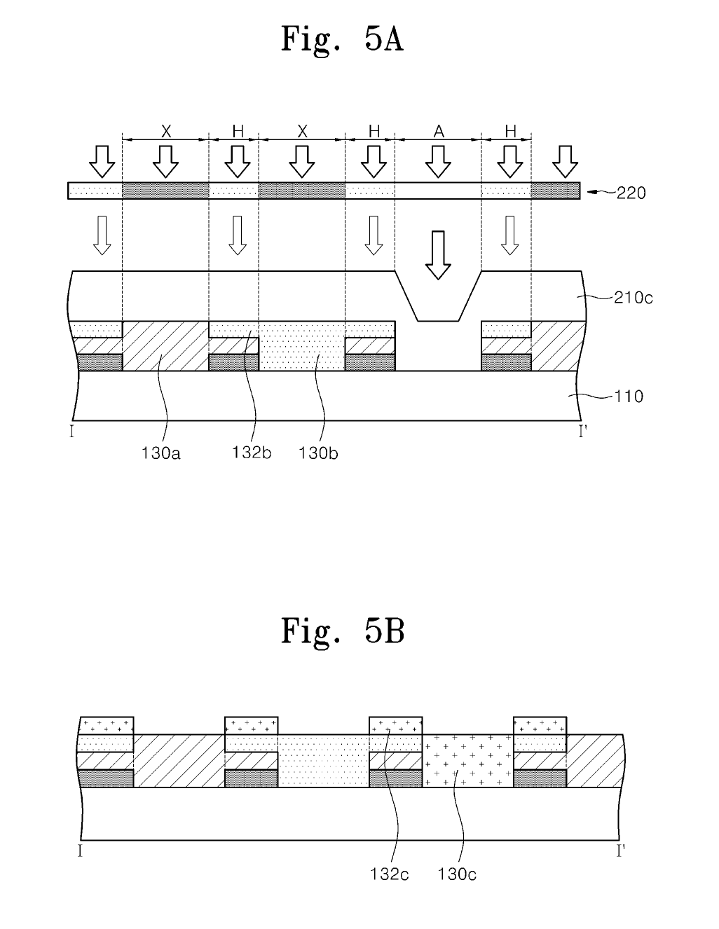

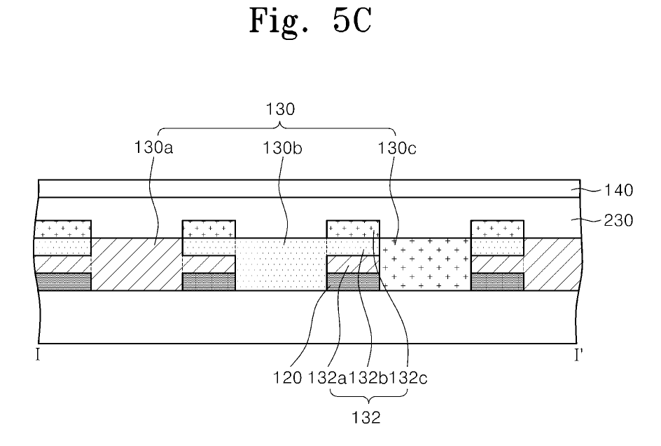

The light blocking color filter 132 can further include a green light blocking color filter using a green (G) color resist. As shown in FIG. 3, the green (G) spectrum exhibits a high transmission rate characteristic in an intermediate wavelength band of 450 to 650 nm. Accordingly, if the green light blocking color filter is additionally provided, a wavelength region in which light is absorbed can be further extended such that the effect of the black matrix 120 can be further enhanced. An overcoat layer 230 (as shown in FIG. 5C) can be included to planarize surfaces of the color filter 130 and the light blocking color filter 132.

Herein, the color resist may be characterized in that a region that is not exposed to light is developed and a pattern of a region exposed to light remains in a photoresist process using a negative type mask. Even when a black matrix region is filled with a color resist, a process can be simplified without increasing the material cost.

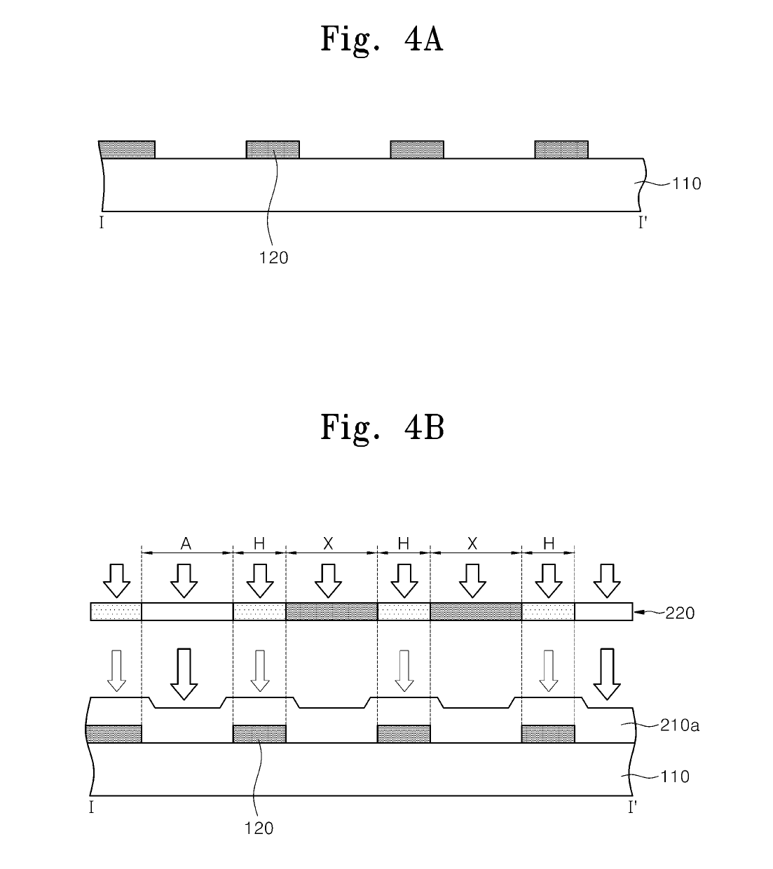

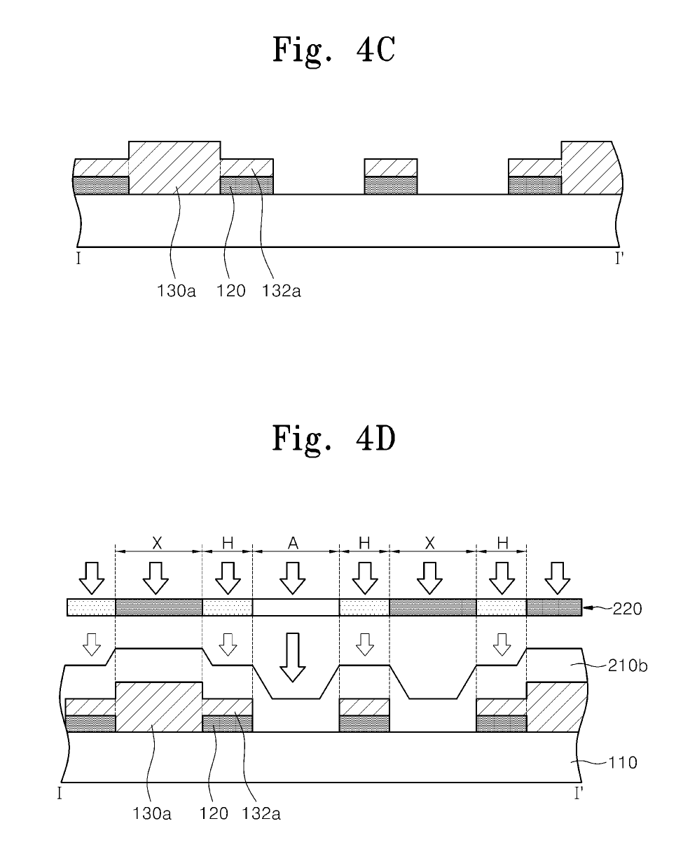

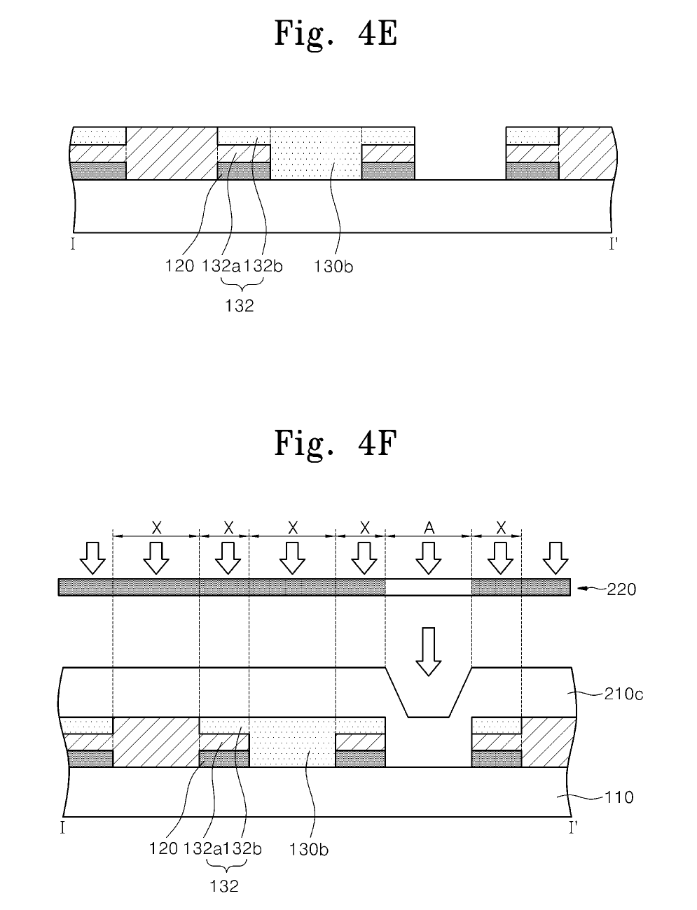

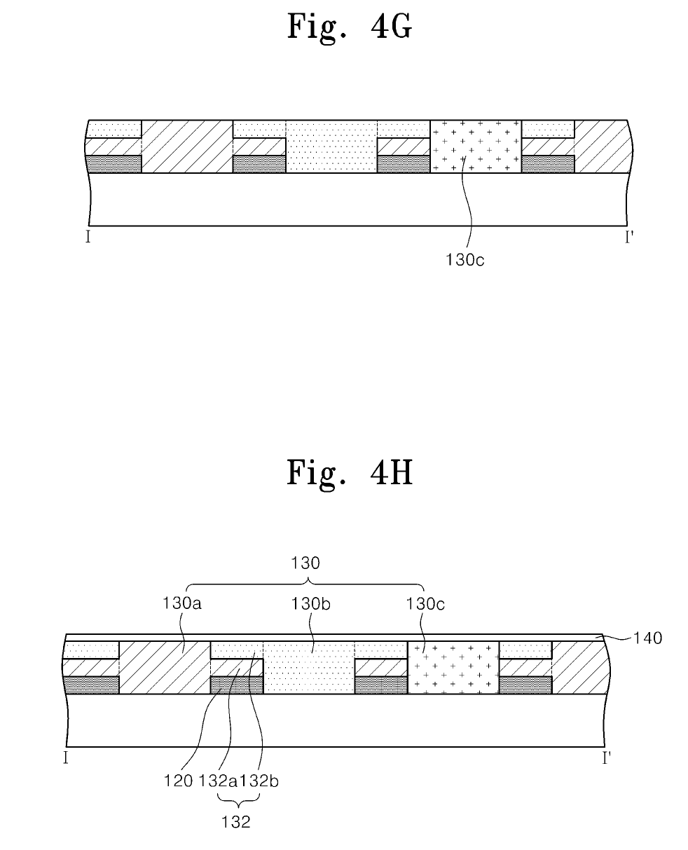

FIG. 4A, FIG. 4B, FIG. 4C, FIG. 4D, FIG. 4E, FIG. 4F, FIG. 4G, and FIG. 4H are cross-sectional views illustrating a method for manufacturing the color filter substrate for the LCD according to a first exemplary embodiment of the present invention.

Referring to FIG. 4A, a black matrix 120 is formed on an upper substrate 110. The black matrix 120 can be deposited and formed using a mask. The black matrix 120 may be spaced and formed at a predetermined interval corresponding to a non-pixel region Q to separate adjacent pixel regions P.

Referring to FIG. 4B and FIG. 4C, a blue (B) color filter 130a and a blue light blocking color filter 132a are formed. As shown in FIG. 4B, a blue color resist 210a is coated on the entire surface on the upper substrate 110 on which the black matrix 120 is formed. Herein, the blue color resist 210a may be coated using a method of spin coating or roll coating.

Spin coating uniformly spreads a color resist on the entire upper substrate 110 by rotating the upper substrate 110 at a high rate while the color resist flows onto the upper substrate 110. The roll coating method transfers and prints the color resist arranged on a roll to the upper substrate 110.

A main component of the blue color resist 210a can be constituted with an organic pigment for realizing the colors and a photosensitive composition such as a photopolymerization initiator, monomer, binder or the like as in the general photoresist.

Next, the blue color resist 210a is selectively exposed by illuminating ultraviolet (UV) rays after masking using a half tone mask 220. The half tone mask 220 may include a transmissive portion A for transmitting light, a light shielding portion X for preventing light from being transmitted, and a semi-transmissive portion H for transmitting only a portion of light on an upper part of the blue color resist 210a.

Additionally, an exposure method can include a proximity method for exposing an original pattern with sunlight, a stepper method for repeatedly exposing a reduced pattern, or a mirror projection method for projecting and exposing a mask pattern.

The blue color resist 210a having a photochemical structure that is changed by the exposure is hardened and developed at a high temperature of about 230° C. Thus, a blue color filter 130a is formed in the pixel region P corresponding to the transmissive portion A of the half tone mask 220, and the blue light blocking color filter 132a is formed on the black matrix 120 in the non-pixel region Q corresponding to the semi-transmissive portion H of the half tone mask 220 as shown in FIG. 4C.

Since the blue color resist 210a may be a negative type according to this exemplary embodiment, an unexposed region is developed without any pattern and the exposed region remains with a pattern. Therefore, there is minimal additional material cost, if any, for the color resist used to form the blue light blocking color filter 132a.

When the blue color resist 210a is developed and the blue color filter 130a is formed, a part corresponding to the semi-transmissive portion H is partially exposed without being completely removed upon development and remains at a predetermined thickness on the black matrix 120 such that the blue light blocking filter 132a is formed.

Referring to FIG. 4D and FIG. 4E, a red (R) color filter 130b and a red color blocking filter 132b are formed. As shown in FIG. 4D, a red color resist 210b is coated on the entire surface on the upper substrate 110 on which the blue (B) color filter 130a and the blue light blocking color filter 132a are formed.

Next, the red color resist 210b is selectively exposed by illuminating UV rays after masking using a half tone mask 220 including a transmissive portion A, a light shielding portion X, and a semi-transmissive portion H on an upper part of the red color resist 210b.

The red color resist 210b having a photochemical structure that is changed by the exposure is hardened and developed at a high temperature of about 230° C. Thus, a red color filter 130b is formed in the pixel region P corresponding to the transmissive portion A of the half tone mask 220, and the red light blocking color filter 132b is formed on the blue light blocking color filter 132a in the non-pixel region Q corresponding to the semi-transmissive portion H of the half tone mask 220 as shown in FIG. 4E.

When the red color resist 210b is developed and the red color filter 130b is formed, a part corresponding to the semi-transmissive portion H is partially exposed without being completely removed upon development and remains at a predetermined thickness on the blue light blocking color filter 132a such that the red light blocking color filter 132b is formed.

Referring to FIG. 4F and FIG. 4G, a green (G) color filter 130c is formed. As shown in FIG. 4F, a green color resist 210c is coated on the entire surface on the upper substrate 110 on which the red color filter 130b and the red light blocking color filter 132b are formed.

Next, the green color resist 210c is selectively exposed by illuminating UV rays after masking using a mask 220 including a transmissive portion A for transmitting light and a light shielding portion X for preventing light from being transmitted on an upper part of the green color resist 210c.

The green color resist 210c having a photochemical structure that is changed by the exposure is hardened and developed at a high temperature of about 230° C. Thus, the green color filter 130c is formed in the pixel region P corresponding to the transmissive portion A of the mask 220 as shown in FIG. 4G.

Since blue and red wavelengths absorb lights of short and long wavelengths, the light blocking color filter 132 including the blue light blocking color filter 132a stacked with the red light blocking color filter 132b on the black matrix 120 can function as a black matrix.

When considering light blocking characteristics and costs of the black matrix 120, the black matrix 120 can have a thickness of 0.5 μm to 1.0 μm and the light blocking color filter 132 can have a thickness of 0.5 μm to 1.05 μm.

Then, as shown in FIG. 4H, a common electrode 140 may be formed.

The common electrode 140 can be deposited and formed by sputtering a transparent electrode material on the upper substrate 110 on which the color filter 130 and the light blocking color filter 132 are formed. The transparent electrode material may be Indium Tin Oxide (ITO) or Indium Zinc Oxide (IZO), which have good light transmissivity, conductivity, and superior chemical and thermal stabilities.

This common electrode 140 operates a liquid crystal cell together with a pixel electrode 90 formed in a TFT substrate 40.

In another exemplary embodiment of the present invention, a green light blocking color filter can be formed on the red light blocking color filter 132b, either while the green color filter 130c is formed or at a different step of manufacturing.

FIG. 5A, FIG. 5B, and FIG. 5C are cross-sectional views illustrating a method for manufacturing a color filter substrate for an LCD according to another exemplary embodiment of the present invention. Since the steps other than the step of forming a green color filter 130c are identical as those described above, only the step of forming the green color filter 130c will be described.

Referring to FIG. 5A, FIG. 5B, and FIG. 5C, a green color resist 210c may be coated on the entire surface on an upper substrate 110 on which the blue color filters 130a, red color filters 130b, a blue light blocking color filter 132a, and a red light blocking color filter 132b are formed as shown in FIG. 5A. Subsequently, the green color resist 210c is selectively exposed using a half tone mask 220 including a transmissive portion A, a light shielding portion X, and a semi-transmissive portion H.

When the green color resist 210c is developed and the green color filter 130c is formed, a part corresponding to the semi-transmissive portion H is partially exposed without being completely removed upon development and remains as the green light blocking color filter 132c having a predetermined thickness as shown in FIG. 5B.

As shown in FIG. 5C, an overcoat layer 230 can be formed to planarize surfaces of a color filter 130 and the green light blocking color filter 132c. In this case, a black matrix function of the light blocking color filter 132 can be improved since a wavelength region capable of absorbing light is further extended. Further, a common electrode 140 may be formed on the overcoat layer 230.

According the previously described exemplary embodiments of the present invention, the color resist has been a negative type resist for forming a color filter and a light blocking color filter. However, a positive type resist could be used without deviating from the scope of the invention.

Moreover, an example in which light blocking color filters of blue, red, and green are sequentially formed on the black matrix 120 has been described in these exemplary embodiments, but this sequence of forming the light blocking color filters can be adjusted and/or truncated without deviating from the scope of the invention.

Additionally, instead of being formed on the upper substrate 110, the color filters 130, light blocking color filters 132, and black matrix 120 may all be formed on the lower substrate 10. In this case, the LCD device may have an array on color filter (“AOC”) structure, in which a TFT array, such as gate wiring, is disposed on the color filters 130, light blocking color filters 132, and black matrix 120, or a color filter on array (“COA”) structure, in which the color filters 130, light blocking color filters 132, and black matrix 120 are disposed on the TFT array.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A color filter substrate for a liquid crystal display (LCD), comprising:
a substrate comprising a non-pixel region separating a first pixel region from a second pixel region; and
a black matrix layered with a light blocking color filter in the non-pixel region, the light blocking color filter comprising a first color filter overlapping with a second color filter,
wherein the first color filter extends into the first pixel region and the second color filter extends into the second pixel region.

2. The color filter substrate of claim 1, wherein the first color filter comprises a red color filter, a green color filter, or a blue color filter.

3. The color filter substrate of claim 1, wherein the light blocking color filter comprises at least one of a first red color filter, a first green color filter, and a first blue color filter overlapping with at least one of a second red color filter, a second green color filter, and a second blue color filter.

4. The color filter substrate of claim 1, wherein the light blocking color filter comprises a red color filter and a blue color filter layered with the black matrix.

5. The color filter substrate of claim 1, wherein the black matrix has a thickness of 0.5 μm to 1.0 μm.

6. The color filter substrate of claim 1, wherein the light blocking color filter has a thickness of 0.5 μm to 1.05 μm.

7. The color filter substrate of claim 1, further comprising:
a common electrode arranged on the first color filter, the second color filter, and the light blocking color filter.

8. The color filter substrate of claim 1, further comprising:
an overcoat layer arranged on and the first color filter, the second color filter, and the light blocking color filter, the overcoat layer to planarize the first color filter, the second color filter, and the light blocking color filter; and
a common electrode arranged on the overcoat layer.

9. A method for manufacturing a color filter substrate, comprising:
forming a black matrix in a non-pixel region of a substrate, the black matrix to separate a first pixel region from a second pixel region;
forming a first color filter in the first pixel region;
forming a second color filter in the second pixel region; and
forming a light blocking color filter in the non-pixel region, the light blocking color filter comprising the first color filter overlapping with the second color filter.

10. The method of claim 9, wherein the first color filter comprises a red color filter, a green color filter, or a blue color filter.

11. The method of claim 9, wherein the light blocking color filter comprises at least one of a first red color filter, a first green color filter, and a first blue color filter overlapping with at least one of a second red color filter, a second green color filter, and a second blue color filter.

12. The method of claim 9, wherein the light blocking color filter comprises a red color filter and a blue color filter.

13. The method of claim 9, wherein the black matrix has a thickness of 0.5 μm to 1.0 μm.

14. The method of claim 9, wherein the light blocking color filter has a thickness of 0.5 μm to 1.05 μm.

15. The method of claim 9, wherein forming the light blocking color filter comprises coating and patterning at least one of a red color resist, a blue color resist, and a green color resist on the substrate.

16. The method of claim 15, wherein the patterning is performed using photolithography.

17. The method of claim 9, further comprising:
forming a common electrode on the first color filter, the second color filter, and the light blocking color filter.

18. The method of claim 9, further comprising:
forming an overcoat layer on the first color filter, the second color filter, and the light blocking color filter, the overcoat layer to planarize the first color filter, the second color filter, and the light blocking color filter; and
forming a common electrode on the overcoat layer.

19. A liquid crystal display (LCD), comprising:
a substrate comprising a first pixel region arranged between a first non-pixel region and a second non-pixel region, and a second pixel region arranged between the second non-pixel region and a third non-pixel region;
a black matrix arranged in each of the first non-pixel region, the second non-pixel region, and the third non-pixel region;
a first color filter arranged in the first pixel region, the first non-pixel region, and the second non-pixel region; and
a second color filter arranged in the second pixel region, the second non-pixel region, and the third non-pixel region,
wherein the first color filter overlaps with the second color filter in the second non-pixel region.

20. The LCD of claim 19, wherein the first color filter completely covers the black matrix in the second non-pixel region, and the second color filter completely covers the first color filter in the second non-pixel region.
